(19) United States
(12) Patent Application Publication
(10) Pub. No.: US 2007/0261065 A1
(43) Pub. Date: Nov. 8, 2007

(54) FRAMEWORK FOR GENERATING PRE-PACKAGED BUSINESS INTEGRATION COMPONENT GROUP PATTERN-BASED APPLICATIONS

(76) Inventors: Kenneth L. Astl, San Antonio, TX (US); Pranta Das, Fremont, CA (US); Xiaochun Mei, Palo Alto, CA (US); Edwin V. Sapugay, San Mateo, CA (US); Randall Scott Theobald, Pflugerville, TX (US)

Correspondence Address: DUKE W. YEE, P.O. BOX 802333, YEE & ASSOCIATES, P.C., DALLAS, TX, 75380, US

(21) Appl. No.: 11/379,526

(22) Filed: Apr. 20, 2006

(51) Int. Cl. G06F 9/44

(52) U.S. Cl. 719/320

(57) ABSTRACT

A computer implemented method, apparatus, and computer program usable program code for managing a number of application integration components. A first command is issued to a first application group. The first application group includes a first subset of application integration components selected from a number of application integration components. The first command causes at least one application integration component in the first subset of application integration components to be adjusted based on a first policy. Responsive to issuing the first command, and based on a second policy, a second command is issued to a second application group. The second application group includes a second subset of application integration components selected from the number of application integration components. The second command causes at least one application integration component in the second subset of application integration components to be adjusted based on the second policy.

### BACKGROUND OF THE INVENTION

1. Field of the Invention

The present invention relates generally to data processing systems and in particular to generating control groups for business integration applications. Still more particularly, the present invention relates to a computer implemented method, apparatus, and computer usable program code for control groups that allow business application policy enforcement across multiple control groups.

2. Description of the Related Art

Modern businesses often employ highly complex arrays of computers and applications to implement a business goal. For example, hundreds or even thousands of servers may implement an Internet-based business that receives, processes, and monitors customer orders. The process of coordinating these computers and their corresponding applications can be daunting.

The process of coordinating computers and corresponding applications becomes even more daunting when one business desires to integrate with another business. For example, if two banks merge, then their information technology systems also are merged. At a minimum, each bank's information technology systems interact with each other so that a customer only deals with one set of banking policies of the purchasing bank.

To better manage these problems, application integration software or business integration software has been developed to coordinate various information technology systems. However, application integration software uses a vast array of communications software, adapters, process components, translation components known as mediator components, and a host of other components that each serve a different function in coordinating an overall business system or business model. Thus, managing application integration software itself can entail a complex and difficult management problem.

### SUMMARY OF THE INVENTION

The present invention provides a computer implemented method, apparatus, and computer program usable program code for managing a number of application integration components. A first command is issued to a first application group. The first application group includes a first subset of application integration components selected from a number of application integration components. The first command causes at least one application integration component in the first subset of application integration components to be adjusted based on a first policy. Responsive to issuing the first command, and based on a second policy, a second command is issued to a second application group. The second application group includes a second subset of application integration components selected from the number of application integration components. The second command causes at least one application integration component in the second subset of application integration components to be adjusted based on the second policy.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a network of data processing systems in which aspects of the present invention can be implemented;

FIG. 2 is a block diagram of a data processing system in which aspects of the present invention can be implemented;

FIG. 3 is a block diagram of a process server system in which aspects of the present invention can be implemented;

FIG. 4 is a block diagram of a process server system in which aspects of the present invention can be implemented;

FIG. 5 is a block diagram of a process server system with groups, in accordance with an illustrative example of the present invention;

FIG. 6 is a block diagram of a physical server, in accordance with an illustrative example of the present invention;

FIG. 7 is a block diagram of an application server, in accordance with an illustrative example of the present invention;

FIG. 8 is a block diagram of an event delivery interaction pattern in a business integration server model with groups, in accordance with an illustrative example of the present invention;

FIG. 9 is a block diagram of a process initiated request interaction pattern in a business integration server model with groups, in accordance with an illustrative example of the present invention;

FIG. 10 is a block diagram of an enterprise information system initiated request interaction pattern in a business integration server model with groups, in accordance with an illustrative example of the present invention;

FIG. 11 is a block diagram of an application development process using groups of the present invention, in accordance with an illustrative example of the present invention; and

FIG. 12 is a flowchart illustrating generation and use of business integration component group pattern-based applications, in accordance with an illustrative example of the present invention.

FIG. 13 shows pseudo-code that describes the policy-type transaction in a service component architecture.

### DETAILED DESCRIPTION OF THE PREFERRED EMBODIMENT

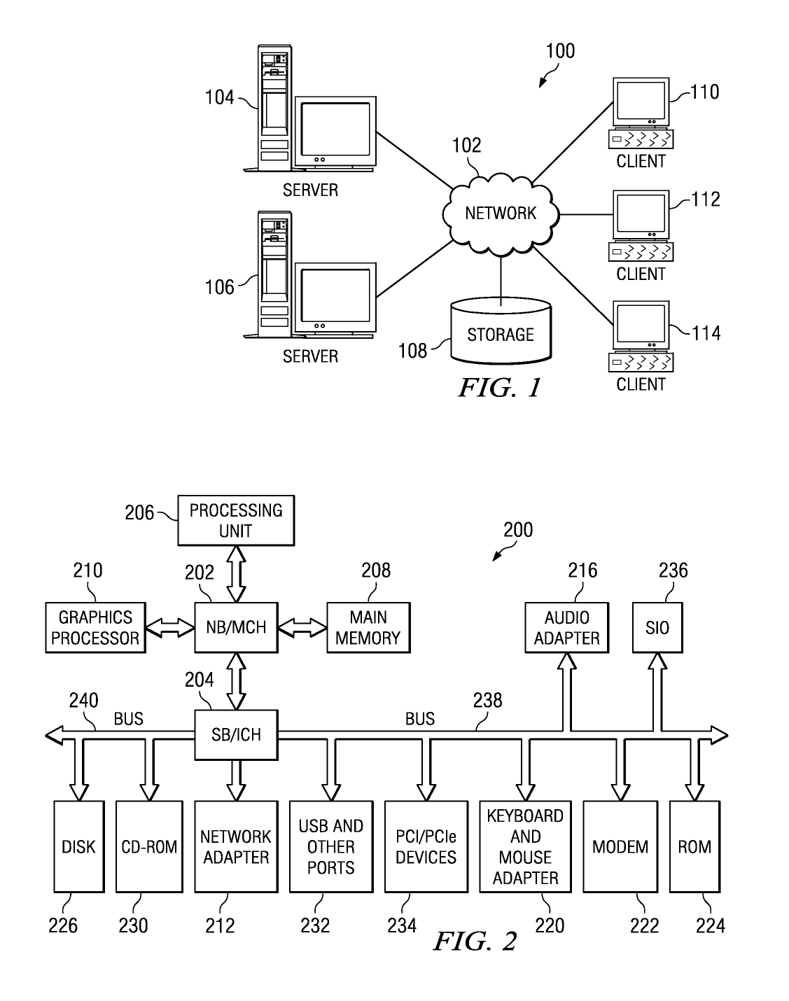

FIGS. 1-2 are provided as exemplary diagrams of data processing environments in which embodiments of the present invention can be implemented. It should be appreciated that FIGS. 1-2 are only exemplary and are not intended to assert or imply any limitation with regard to the environments in which aspects or embodiments of the present invention can be implemented. Many modifications to the depicted environments may be made without departing from the spirit and scope of the present invention.

FIG. 1 is a block diagram of a network of data processing systems in which aspects of the present invention can be implemented. Network data processing system 100 is a network of computers or data processing systems in which embodiments of the present invention can be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also can be implemented as a number of different types of networks, such as for example, an intranet, a local area network (LAN), or a wide area network (WAN). FIG. 1 is intended as an example, and not as an architectural limitation for different embodiments of the present invention.

FIG. 2 is a block diagram of a data processing system in which aspects of the present invention can be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system can be implemented using any type of communications fabric or architecture that provides for transmission of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for managing a number of application integration components. A first command is issued to a first application group. The first application group includes a first subset of application integration components selected from a number of application integration components. The first command causes at least one application integration component in the first subset of application integration components to be adjusted based on a first policy. Responsive to issuing the first command, and based on a second policy, a second command is issued to a second application group. The second application group includes a second subset of application integration components selected from the number of application integration components. The second command causes at least one application integration component in the second subset of application integration components to be adjusted based on the second policy.

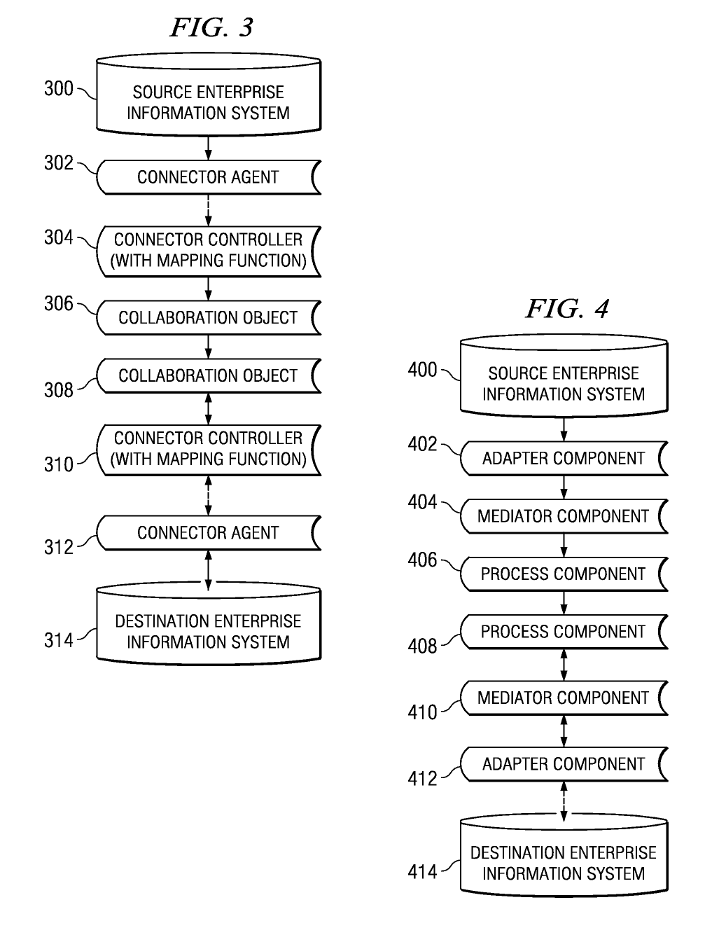

FIG. 3 is a block diagram of a process server system in which aspects of the present invention can be implemented. The process server system shown in FIG. 3 can be implemented using a number of data processing systems, such as clients 110, 112, and 114 in FIG. 1, servers 104 and 106 in FIG. 1, and data processing system 200 in FIG. 2.

The process server system shown in FIG. 3 includes source enterprise information system 300 and destination enterprise information system 314. Both source enterprise information system 300 and destination enterprise information system 314 can be implemented using one or more related applications running on one or more data processing systems. The applications are related in that all of the applications are components in a business system. For example, an enterprise information system can be a collection of applications directed towards processing customer orders. One application presents offers to a customer, a second application receives customer orders, a third application tracks inventory, a fourth application prompts for orders to be shipped, and other applications in the enterprise information system may perform other functions directed toward enabling the overall business operation.

In the example shown in FIG. 3, source enterprise information system 300 and destination enterprise information system 314 are separate enterprise information systems. Separate enterprise information systems may be maintained in the case that one business acquires another. In this case, the purchasing business desires to have source enterprise information system 300 to work with destination enterprise information system 314 to achieve a common business goal. Separate enterprise information systems may also be maintained because different applications or enterprise information systems are executed on different kinds of operating systems. Other reasons exist for why source enterprise information system 300 and destination enterprise information system 314 are separate but are called upon to act together to achieve a business goal.

To allow source enterprise information system 300 and destination enterprise information system 314 to successfully interact, a user utilizes agents and objects to communicate with the two enterprise information systems. Connector agent 302 communicates with connector controller 304 and allows connector agent 302 to interact with connector controller 304. Connector controller 304 communicates with connector agent 302 using a variety of transport protocols, such as message queuing protocol, Java messaging service protocol, Internet interoperable orb protocol, and other protocols. Connector controller 304 provides any desired mapping functions that allow events in enterprise information system 300 to be used with collaboration object 306. For example, the data in the event can be in an application specific format. Connector controller 304 converts the data in the event to a format used by collaboration agent 306.

In this example, collaboration object 306 is a set of applications that allow source enterprise information system 300 to interact with destination enterprise information system 314 in a desired manner. This set contains one ore more applications. For example, collaboration object 306 may process the converted data provided by connector controller 304 to process an order. Thus, a collaboration object can contain business logic to determine how a business process that spans multiple enterprise information systems will be integrated. An example of a collaboration object is a contact-manager canonical business process that synchronizes contact business objects in a variety of back-end enterprise information systems such as Systems, Applications, and Processes; Siebel; and other systems. Additional examples of collaboration objects may be found in documentation for ContactSynch software version 2.0, which is provided by CROSSWORLDS® Software. Additional collaboration objects may also be provided, such as collaboration object 308. In the example shown in FIG. 3, collaboration object 306 communicates with collaboration object 308, though the relationship among collaboration objects can change and more or less collaboration objects can be provided.

In turn, collaboration object 308 communicates with connector controller 310. Connector controller 310 also has a mapping function that allows data received from collaboration object 308 to be converted to a format usable by destination enterprise information system 314. Connector agent 312 then allows data to pass to destination enterprise information system 314.

Thus, for example, a collaboration object can be tied to other collaboration objects to form a group of collaboration objects that handles one or more events generated by source enterprise information system 300. When a collaboration object processes an event, the collaboration object can communicate with another enterprise information system, such as destination enterprise information system 314, via connector agent 312 and connector controller 310. The example of FIG. 3 shows this type of communication as a request-response communication.

A request-response communication is a basic concept of client-server communication. In a request-response communication, a client data processing system communicates a request for services of a server data processor system. In response, the server data processing system communicates a response, possibly including the requested services. In an illustrative example, a program on a server data processing system implements certain services. Other programs on client data processing systems o invoke those services. The client and server can reside on different data processing systems and can run on different operating systems. In this case, the only form of communication is by sending messages as no shared memory or shared disks exists

In the depicted example in FIG. 3, data flows from source enterprise information system 300 to destination enterprise information system 314. However, data may also flow in the reverse direction, from destination enterprise information system 314 to source enterprise information system 300.

FIG. 4 is a block diagram of a process server system in which aspects of the present invention can be implemented. The process server system shown in FIG. 4 can be implemented using a number of data processing systems, such as clients 110, 112, and 114 in FIG. 1, servers 104 and 106 in FIG. 1, and data processing system 200 in FIG. 2. In addition, the process server system shown in FIG. 4 provides an example of how a WEBSPHERE BUSINESS INTEGRATION® system may implement the more generic system shown in FIG. 3. The WEBSPHERE BUSINESS INTEGRATION® system is available from International Business Machines Corporation. Each individual component in a group shown in FIG. 4 may be characterized as an application integration component. An application integration component is any component that performs a function in an enterprise integration system, such as those described herein.

Like the system illustrated in FIG. 3, source enterprise information system 400 and destination enterprise information system 414 can be one or more related applications running on one or more data processing systems. The applications are related in that all of the applications are components in a business system. Source enterprise information system 400 communicates with adapter component 402, which serves to facilitate communication between source enterprise information system 400 and the other components shown in FIG. 4. An adapter component is a component that allows other integration components, such as process components, to interface with enterprise information systems (EIS) and back-end systems, such as SAP and Siebel, via Java 2 Enterprise Edition (J2EE) connector architecture (JCA) resource adapters or via Java messaging service (JMS) queues. Similarly, destination enterprise information system 414 communicates with adapter component 412, which serves to allow communication between destination enterprise information system 414 and the other components shown in FIG. 4. Adapter components 402 and 412 can be implemented using Service component architecture adapter components available in the WEBSPHERE BUSINESS INTEGRATION® system. Similarly, mediator components 404 and 410 can be Service component architecture mediator components available in the WEBSPHERE BUSINESS INTEGRATION® system.

Adapter component 402 communicates with mediator component 404. Similarly, adapter component 412 communicates with mediator component 410. Adapter components 402 and 412 facilitate data communication between source enterprise information system 400 and destination enterprise information system 414. Mediator components 404 and 410 translate data transmitted from source enterprise information system 400 and destination enterprise information system 414 into a format usable by process component 406 and process component 408. Thus, adapter components 402 and 412 are similar to connector controllers 302 and 312 in FIG. 3 and mediator components 402 and 412 are similar to connector controllers 304 and 310 shown in FIG. 3.

Process components 406 and 408 perform processes on data from either source enterprise information system 400 or destination enterprise information system 414. For example, process component 406 may process the converted data provided by mediator component 404 to process an order. Thus, a process component can contain business logic to determine how a business process that spans multiple enterprise information systems will be integrated. An example of a process component is a component that determines whether a claimant is eligible to receive payment of a claim in an insurance processing system. Another example of a process component is a component that integrates a business process between two enterprise information systems. Additional process components may also be provided, such as process component 408. In the example shown in FIG. 4, process component 406 communicates with process component 408 as the two processes work together toward some business goal. The relationship among process components can change and more or less process components can be provided. Thus, comparing collaboration objects 306 and 308 in FIG. 3 to process components 406 and 408 in FIG. 4, a collaboration object's function is implemented by a Service component architecture process component in the WEBSPHERE BUSINESS INTEGRATION® system.

In the process server systems shown in FIG. 3 and FIG. 4, each component, agent, controller, or object is an indivisible component. An indivisible component means that the application or applications that form a component do not operate independently with respect to the process server system. However, certain components have a closer relationship than others, and share the same administrative semantics. Similar components can be grouped together to make administering individual components easier and to allow additional qualities of service to be provided to the overall process server system.

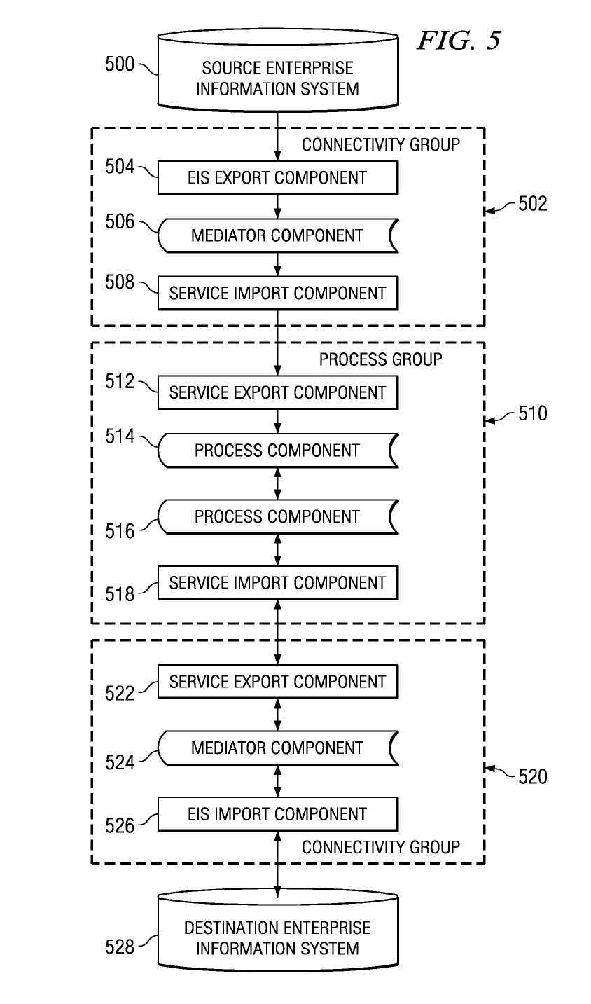

FIG. 5 is a block diagram of a process server system with groups, in accordance with an illustrative example of the present invention. The process server system shown in FIG. 5 can be implemented using a number of data processing systems, such as clients 110, 112, and 114 in FIG. 1, servers 104 and 106 in FIG. 1, and data processing system 200 in FIG. 2. In addition, the process server system shown in FIG. 5 uses the WEBSPHERE BUSINESS INTEGRATION® system shown in FIG. 4. However, the system shown in FIG. 5 can also be implemented in the process server system shown in FIG. 3. To facilitate management of the various components shown in FIG. 5, all components are placed into three groups. Process components are placed into a single process group 510 and connectivity components are placed into connectivity group 520. Groups may be implemented as Service component architecture modules in the WEBSPHERE BUSINESS INTEGRATION® system. Each individual component in a group shown in FIG. 5 may be characterized as an application integration component in these examples.

The process server system shown in FIG. 5 includes source enterprise information system 500, which is similar to source enterprise information system 400 described in FIG. 4. Source enterprise information system 500 communicates with connectivity group 502. Connectivity group 502 includes several connectivity components, including enterprise information system export component 504, mediator component 506, and enterprise information system (EIS) import component 508. Enterprise information system component 504 provides any necessary applications and/or hardware necessary to communicate data to and from source enterprise information system 500. Mediator component 506 contains any necessary applications and/or hardware necessary to translate data from source enterprise information system 500 into a format usable by process components 514 and/or 516. Enterprise information system import component 508 provides any necessary applications and/or hardware necessary to communicate data to and from process group 510.

Similarly, the process server system shown in FIG. 5 includes destination enterprise information system 528, which is similar to destination enterprise information system 414 described in FIG. 4. Destination enterprise information system 528 communicates with connectivity group 520. Connectivity group 520 includes several connectivity components, including enterprise information system (EIS) export component 522, mediator component 524, and enterprise information system (EIS) import component 526. Destination enterprise information system component 528 provides any necessary applications and/or hardware necessary to communicate data to and from source enterprise information system 500. Mediator component 506 contains any necessary applications and/or hardware necessary to translate data from source enterprise information system 500 into a format usable by process components 514 and/or 516. Enterprise information system import component 508 provides any necessary applications and/or hardware necessary to communicate data to and from process group 510.

Process group 510 includes a number of process components, including process component 514, process component 516, enterprise information system export component 512 and enterprise information system import component 518. Enterprise information system export component 512 and enterprise information system import component 518 allow communication between corresponding components in connectivity group 502 and connectivity group 520. Specifically, enterprise information system export component 512 communicates with enterprise information system import component 508 and enterprise information system import component 518 communicates with enterprise information system export component 522. Process group 510 promotes modularization of business processes. Process group 510 also enables simpler processes to be bound together to create more complex business processes that can be assembled, deployed, and administered as a group.

Process components 514 and 516 perform processes on data from either source enterprise information system 500 or destination enterprise information system 528. For example, process component 514 may process the converted data provided by connectivity group 502 to process an order. Thus, a process component can contain business logic to determine how a business process that spans multiple enterprise information systems will be integrated. An example of a process component is a component that implements a portion of a business process. Additional process components may also be provided, such as process component 516. In the example shown in FIG. 5, process component 514 communicates with process component 516 as the two processes work together toward some business goal. The relationship among process components can change and more or less process components can be provided. Thus, comparing collaboration objects 306 and 308 in FIG. 3 to process components 514 and 516 in FIG. 5, a collaboration object's function is implemented by a service component architecture process component in the WEBSPHERE BUSINESS INTEGRATION® system.

A user can deploy and administer each group pattern instance independently. A group pattern instance is a wired assembly or module of constituent service component architecture components. Examples of group pattern instances include connectivity group 502, connectivity group 520, and process group 510. For example, an enterprise information system connectivity group that receives orders and customer data can be deployed along with an order process group. While these two groups are running, a customer relationship process group can be added to process customer data received from the same enterprise information system group.

Although FIG. 5 shows two different types of groups, connectivity groups 502 and 520 and process group 510, additional types of groups may be created to better administrate a complex process server system. A connectivity group is a group that contains an adapter component and a mediator component as focal components. For example, a group could be designated a monitoring group. A monitoring group has applications and/or hardware designed for monitoring process components. In another example, a process server system could also have groups directed toward sub-processes. In this case, process component 514 can be in a separate process group than process component 516. Furthermore, more or fewer process groups or connectivity groups may also be provided than shown in FIG. 5.

Administering process components, connectivity components, and other types of components via groups is desirable because groups allow one or more commands to be implemented to all components in a group, versus applying commands to individual components in a group. Different types of groups are desirable because process components should be managed independently of connectivity components, and other types of components should also be managed independently of each other.

For example, when a connectivity component is shut down due to administration of the process server system, other processes associated with that connectivity component preferably should not be shut down in order to minimize disruption to the system. Administration of the process server system could be performing a backup command or applying a patch or one or more updates to software associated with a connectivity component or a process component. In this example, operation of the process server system should continue as if administration is not occurring. In other examples, identifying a group of process components that will be initiated on delivery of an event is desirable in order to administer the process components together when stopping process events is necessary.

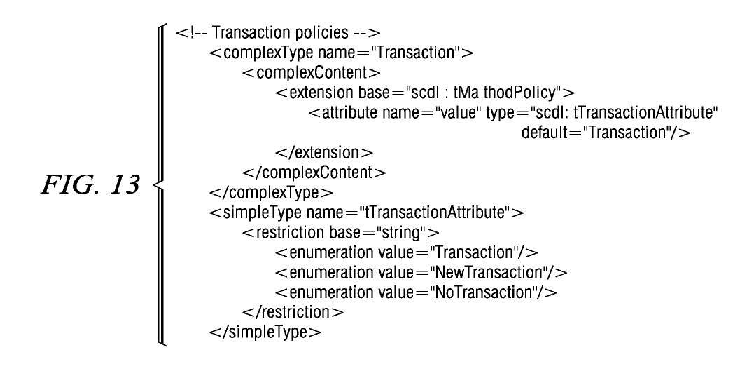

Furthermore, several qualities of service can be provided when components are grouped together. Qualities of service may be implemented as service component architecture policies in a WEBSPHERE BUSINESS INTEGRATION® system. A service component architecture policy is a declarative method of requesting a quality of service on a service component architecture component without having to change the service component architecture client or the service component architecture component implementation. Samples of policies are transaction, security, interaction style, and so on. The pseudo-code shown in FIG. 13 describes the policy-type transaction. Graphical tools allow a user to apply Service component architecture policies to components in a Service component architecture module. Policies may be validated by Service component architecture validators provided during runtime.

For example, components can act independently of each other. In this case, a mediator component may not need to be aware that an adapter component is not going to send events due to the fact that the adapter component is in a paused state. Pausing the mediator component may not be necessary, but the mediator component should not receive requests from process components or adapter components while the adapter component is paused. Administering the process server system using groups ensures that the correct semantics are applied to all components in the mediator component.

Another example of an added quality of service is providing a default setting for one or more groups. A default setting for a group may be provided so that users need not be concerned with the policies that administer the components in a group. Default settings for a group can also automatically integrate components within the group.

Another example of an added quality of service is that groups allow users to deploy and administer an entire set of components as a single entity. Thus, groups provide a higher level view of connectivity components and process components. The higher level view allows connectivity components and process component to be more easily managed.

Another example of an added quality of service is that group validators are provided that span multiple components. Group validators thus validate that a component is operating correctly from a group perspective as well as a local perspective. Group validators prevent individual components with causing conflicts in groups or between groups. Multiple group validators are designed to communicate with each other to minimize the possibility of redundant and conflicting validations.

As shown above with respect to FIG. 5, groups allow policies to be applied to all components in a group and allow policies to affect the relationships between different groups. Examples of policies that can be applied to groups include state management policies, pause on critical error policies, resiliency policies, event sequencing policies, session policies, isolation service policies, and transaction policies. Each of these is described further below.

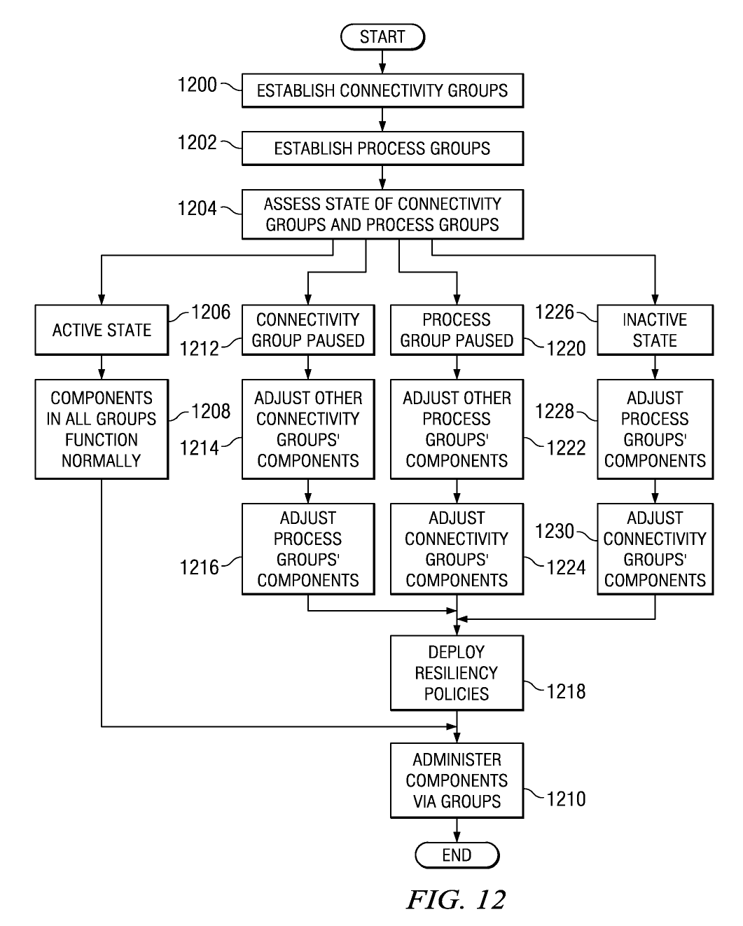

State management policies affect the state of a group. The state of a group can be described as the operational status of a group or of components within the group. Examples of states include active and paused. In an active state, a group is active and performing functions normally. In a paused state, a group completes all pending functions, but does not accept additional commands or requests to perform additional functions. State is further described with respect to FIG. 12. The state of a group can be changed manually by a user or changed automatically in response to events, as provided by state management policies. In the WEBSPHERE BUSINESS INTEGRATION® system, an MBean for a group is generated that maintains any particular state. An MBean is a management bean that is defined by the JMX (Java Management extensions) standard. More information relating to MBeans can be found at jcp.org/aboutJava/communityprocess/final/jsr003/index3.html.

A change in state can have an impact on some qualities of service. For example, if a process component, such as process components 514 or 516, stops, then any events processed by the process component are stored. Once the process component starts again, the stored events are delivered to the process component. A state management policy is applied to all exported interfaces within a group.

A number of example states are shown below for the process server system shown in FIG. 5. One type of valid state for a group is an active state. In an active state, a group is running and is able to accept requests from other groups and from components within the group. An active group can also send requests to other groups or other components within the group. For example, if process group 510 is active, then processes components 514 and 516 operate normally. If connectivity group 502 or connectivity group 520 are active, then these groups provide normal connectivity functions between source enterprise information system 500 and destination enterprise information system 528.

Another type of valid state is a paused state. In the case of a connectivity group, such as connectivity groups 502 and 520, the connectivity group pauses and the components within the connectivity group pause. A connectivity group in a paused state does not accept new requests, such as “fire and forget” requests, from other components or other groups. Any requests currently in progress will continue until completion. In this case, a policy can throw a “CannotProcessMoreEventsException” when the connectivity group receives additional requests from an adapter component. In the case of a process group, the group is paused and does not accept new requests from other groups or components. Any requests currently in progress continue until completion. In this case, a policy can throw a “CannotProcessMoreEventsException” when the process group receives additional requests from a connectivity group or an adapter component.

Another example of a valid state is an inactive state. In this case, the group is stopped and does not accept requests from other components. The group will not send requests to other components. The group and all components in the group are stopped.

Returning to examples of polices that can be applied to groups, another type of policy is a pause on critical error policy. This type of policy ensures that if a critical error occurs during processing, the group in question will automatically transition to a paused state, as described above. The pause on critical error policy can function as described in the following example.

The pause on critical error policy applies an explicit contract with all adapter import components. This contract is applied to all adapter types. The adapter import component throws an exception when one of two events occur. First, if a request arrives that an adapter import component could not send to an enterprise application, then a “CannotHandleRequestException” is thrown. In this case, the request is not in doubt. Second, if a request arrives that an adapter import component tried to send to an enterprise application, but a general failure message is returned, then a “RequestInDoubtException” is thrown. In this case, the request is in doubt.

In either case, the pause on critical error policy catches the above exceptions thrown by the connectivity group and sets the state of the business process group to “paused,” as described above. The process group maintains communication with the connectivity group so that new events will be dispatched and saved for when the process group is rendered active again. When the process group is reactivated after resolving the exceptions, then the stored events are dispatched to the process group and processed normally.

Returning to examples of polices that can be applied to groups, another type of policy is a resiliency policy. A user or an application establishes a resiliency policy to automatically attempt to correct a request failure, such as in the case where a pause on critical error policy is invoked. A resiliency policy is applied to all adapter import interfaces and applies to all adapter types. When a resiliency policy catches an exception, the resiliency policy can take one or more actions. For example, the resiliency policy can start and restart one or more adaptor components. The resiliency policy can also resend a request. The resiliency policy can also throw another exception to a third policy or to some other group or component.

In an illustrative example, based on configuration properties, a resiliency policy performs three functions. First, the resiliency policy automatically resends requests that are not in doubt, as described above Second, the resiliency policy may resends requests that are either in doubt or not in doubt, as described above. Third, the resiliency policy allows exceptions received from adapter components to propagate back to the caller component or group if a number of retries is exceeded. A user can configure the number of retries. When the number of retries is reached or exceeded, then the resiliency policy will stop a connectivity group so that more requests are not sent to a process group.

Returning to examples of polices that can be applied to groups, other types of policies include event sequencing policies, session policies, isolation service policies, and transaction policies. Event sequencing policies can establish the order in which events are processed within a group. Event sequencing policies also can establish the order in which events are processed between groups. Session policies can govern what a given user can do during a particular administration session. An isolation service policy can isolate services when desired. Policies are further described above.

As shown above, a user can build, deploy, and administer groups as a single entity. An Eclipse nature exists for each of the groups described above. The Eclipse framework allows one to associate project natures for different kinds of projects. More information regarding the Eclipse framework can be found help.eclipse.org. In addition, project builders are associated with the eclipse nature. Further details regarding project builders can be found at help.eclipse.org. Project builders can be used to automatically create a startup bean and an MBean. Once an application is deployed, a user manages the application via the MBean. The MBean keeps track of the group state and allows other components to request the MBean when desired. The MBean stores the group state so that when the application is started, the application will be in the same state as when it was inactivated.

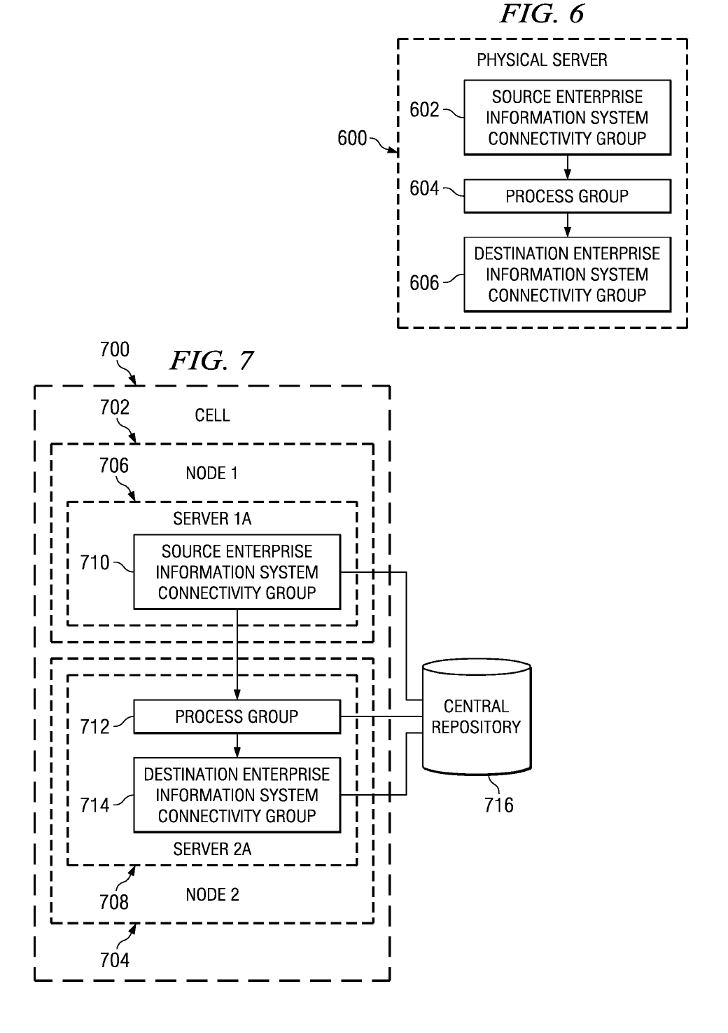

FIG. 6 is a block diagram of a physical server, in accordance with an illustrative example of the present invention. FIG. 6 represents a deployment topology for a process server system. The deployment topology shown in FIG. 6 can be implemented using a number of data processing systems, such as clients 110, 112, and 114 in FIG. 1, servers 104 and 106 in FIG. 1, and data processing system 200 in FIG. 2. In addition, the process server system shown in FIG. 6 uses the WEBSPHERE BUSINESS INTEGRATION® system shown in FIG. 4; however, the topology shown in FIG. 6 can also be implemented in the process server system shown in FIG. 3. Each individual component in a group shown in FIG. 6 may be characterized as an application integration component.

In the exemplary topology shown in FIG. 6, source enterprise information system connectivity group 602, process group 604, and destination enterprise information system connectivity group 606 are implemented in physical server 600. Connectivity groups 602 and 606 communicate with process group 604 primarily using local enterprise Java bean references. Enterprise Java Beans (EJBs) are different from regular Java Beans. Further information regarding enterprise Java beans can be found at java.sun.com/products/ejb/. The arrows indicate the general flow of data; however, data may flow in a direction opposite to the arrows shown.

In the WEBSPHERE BUSINESS INTEGRATION® system, server 600 is a single WEBSPHEREO application server. For fire-and-forget requests, service component architecture destination components using topic bindings for publish-subscribe commands are used to store events between the groups. Fire and forget requests are one-way interactions where the service requester does not require a response. However, for response-request requests, local enterprise Java bean calls are used to store events between groups.

FIG. 7 is a block diagram of an application server, in accordance with an illustrative example of the present invention. FIG. 7 represents a deployment topology for a process server system. The deployment topology shown in FIG. 7 can be implemented using a number of data processing systems, such as clients 110, 112, and 114 in FIG. 1, servers 104 and 106 in FIG. 1, and data processing system 200 in FIG. 2. In addition, the process server system shown in FIG. 7 uses the WEBSPHERE BUSINESS INTEGRATION® system shown in FIG. 4; however, the topology shown in FIG. 7 can also be implemented in the process server system shown in FIG. 3. Each individual component in a group shown in FIG. 7 may be characterized as an application integration component.

In the exemplary topology shown in FIG. 7, source enterprise information system (EIS) connectivity group 710, destination enterprise information system (EIS) connectivity group 714, and process group 712 are deployed in WEBSPHERE® application server cell 700. Source enterprise information system connectivity group 710 is deployed in node 1 702 and in physical server la 706. Process group 712 and destination enterprise information system connectivity group 714 are deployed in node 2 704 and in physical server 2a 708. The arrows indicate the general flow of data; however, data may flow in a direction opposite to the arrows shown.

As in FIG. 6, for fire-and-forget requests, service component architecture destination components using topic bindings for publish-subscribe commands are used to store events between the groups shown in FIG. 7. However, for response-request requests, local enterprise Java bean calls are used to store events between groups.

Each of source enterprise information system connectivity group 710, process group 712, and destination enterprise information system connectivity group 714 can communicate with central repository 716 so that events in any of the three groups may be stored in central repository 716. In addition, central repository 716 maintains relationship tables accessible to both server la 706 and server 2a 708, which each run on different nodes—node 1 702 and node 2 704.

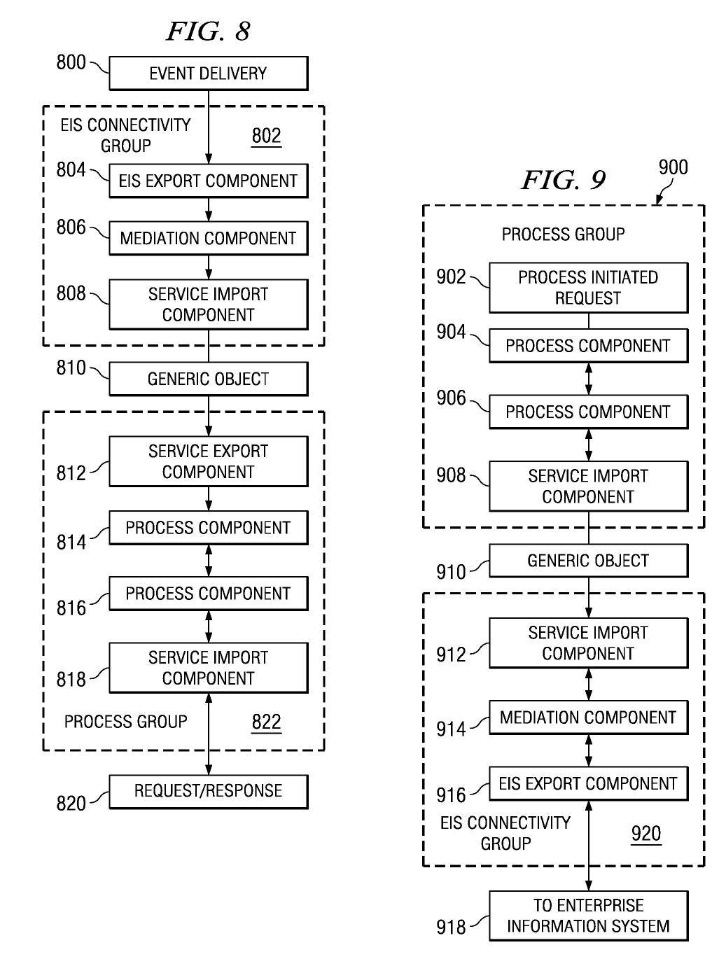

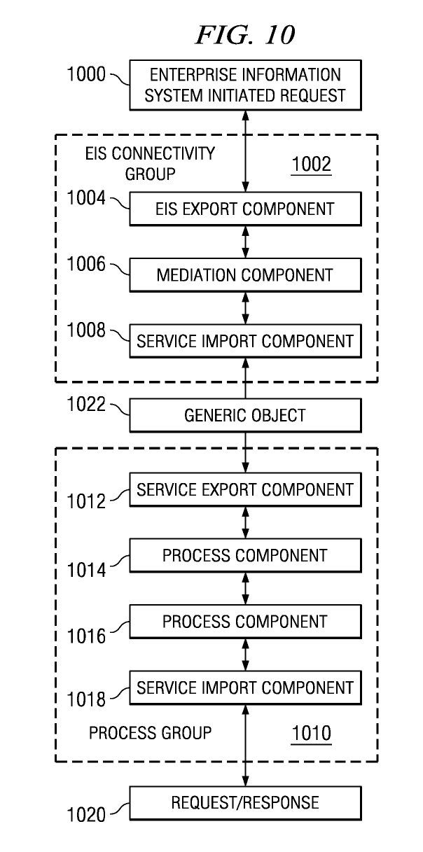

FIG. 8 through FIG. 10 show three interaction patterns supported by group templates. Interaction patterns are those patterns that define the style of communication between components or groups. Examples of interaction patterns are fire-and-forget and request-response. As described herein, group templates are templates a user may use to define a group of components. A group template is a template that allows a designer to define a component group easily much like a Fax template in MICROSOFTWORD® allows a user to create a fax cover page easily. In the following figures, FIG. 8 shows event delivery interaction patterns, FIG. 9 shows process initiated request interaction patterns, and FIG. 10 shows enterprise information system initiated requests.

FIG. 8 is a block diagram of an event delivery interaction pattern in a business integration server model with groups, in accordance with an illustrative example of the present invention. A delivery interaction pattern is of a fire-and-forget nature whereas a request-interaction pattern is of a request-response nature. The event delivery interaction pattern shown in FIG. 8 can be implemented using a number of data processing systems, such as clients 110, 112, and 114 in FIG. 1, servers 104 and 106 in FIG. 1, and data processing system 200 in FIG. 2. In addition, the event delivery interaction pattern shown in FIG. 8 uses the WEBSPHERE BUSINESS INTEGRATION® system shown in FIG. 4; however, the event delivery interaction pattern shown in FIG. 8 can also be implemented in the process server system shown in FIG. 3. Each individual component in a group shown in FIG. 8 may be characterized as an application integration component.

In the event delivery pattern shown in FIG. 8, event 800 occurs at an enterprise information system application. An event may be a customer order, a request to process a customer order, or any other event in a complex business processing system. An adapter component, such as enterprise information system export component 804 detects event 800 as event 800 flows into enterprise information system connectivity group 802. The data associated with event 800 is incorporated in an application specific object. Mediation component 806 transforms the application specific object into generic object 810, which is usable by process group 822. Generic object 810 is delivered to process group 822 via enterprise information system import component 808 using topic bindings which maintain the list of publishers which are process groups that will use the generic object.

A topic binding is a publish-subscribe concept and is another interaction pattern. Standard client/server architectures and queuing systems assume the client and the server “know” each other through an interface or a queue. In many situations, however, it is more useful to implement systems where the interaction is based on announcing given events. For example, it is more useful to implement systems where the interaction is based on announcing given events when a service publishes messages or events of given type, or when clients subscribe to different types of messages or events. When a service publishes an event, the system looks at a table of subscriptions and forwards the event to the interested clients. This process is usually performed by transferring the event's message into a queue for that client. In the example shown in FIG. 8, process group 822 will use generic object 810; however, other process groups may also simultaneously use generic object 810.

Generic object 810 is delivered to process component 814 via enterprise information system export component 812. Process component 816 also uses generic object 810 and, in addition, interacts with process component 814. Each of process components 814 and 816, and any other process components using generic object 810, initiate a business process which can further send requests to other process components.

In an illustrative example, the interaction between enterprise information system connectivity group 802 and process group 822 is fire-and-forget. In addition, request-response requests 820 may be delivered to other groups in the process server system via service import component 818.

Continuing with exemplary interaction patterns, FIG. 9 is a block diagram of a process initiated request interaction pattern in a business integration server model with groups, in accordance with an illustrative example of the present invention. The process initiated request interaction pattern shown in FIG. 9 can be implemented using a number of data processing systems, such as clients 110, 112, and 114 in FIG. 1, servers 104 and 106 in FIG. 1, and data processing system 200 in FIG. 2. In addition, the event delivery interaction pattern shown in FIG. 9 uses the WEBSPHERE BUSINESS INTEGRATION® system shown in FIG. 4; however, the event delivery interaction pattern shown in FIG. 9 can also be implemented in the process server system shown in FIG. 3. Each individual component in a group shown in FIG. 9 may be characterized as an application integration component.

The process initiated request interaction pattern shown in FIG. 9 highlights the fact that a process can send a request to an enterprise information system connectivity group and receive a response from the enterprise information system group. Therefore, the enterprise information system interacts with other groups in a request-response fashion.

In the process initiated request interaction pattern, process initiated request 902 is received in process group 900. Process initiated request 902 is delivered to process component 904. Process component 904 and process component 906 processes the process initiated request 902. As a result of the process, generic object 910 is generated. Generic object 910 contains data usable by a process component in process group 900. The data in generic object 910 is processed data that is processed as a result of process initiated request 902.

Generic object 910 is transmitted from process group 900, via service import component 908, to enterprise information system connectivity group 920 via service export component 912. Mediation component 914 translates generic object 910 into an application specific format usable by applications in enterprise information system 918. The application specific object is transmitted to enterprise information system 918 via enterprise information system export component 916.

Continuing with exemplary interaction patterns, FIG. 10 is a block diagram of an enterprise information system initiated request interaction pattern in a business integration server model with groups, in accordance with an illustrative example of the present invention. The process initiated request interaction pattern shown in FIG. 9 can be implemented using a number of data processing systems, such as clients 110, 112, and 114 in FIG. 1, servers 104 and 106 in FIG. 1, and data processing system 200 in FIG. 2. In addition, the event delivery interaction pattern shown in FIG. 9 uses the WEBSPHERE BUSINESS INTEGRATION® system shown in FIG. 4; however, the event delivery interaction pattern shown in FIG. 9 can also be implemented in the process server system shown in FIG. 3. Each individual component in a group shown in FIG. 10 may be characterized as an application integration component.

The enterprise information system initiated request interaction pattern shown in FIG. 10 highlights the fact that an enterprise information system can send a request to process group and receive a response from the process group. Therefore, the enterprise information system interacts with other groups in a request-response fashion.

In the enterprise information system initiated request interaction pattern, enterprise information system initiated request 1000 is received in enterprise information system connectivity group 1002. Enterprise information system initiated request 1000 is delivered to enterprise information system export component 1004. Enterprise information system export component 1004 transmits enterprise information system initiated request 1000 to mediation component 1006. Mediation component translates enterprise information system initiated request 1000 into generic object 1022. Generic object 1022 contains data usable by a process component in process group 1010. Generic object 1022 is transmitted from enterprise information system connectivity group 1002 via service import component 1008. Process group 1010 receives generic object 1022 via service export component 1012.

In turn, process component 1014 and process component 1016 perform one or more processes on generic object 1022 to form a processed object. The processed object is transmitted to another enterprise information system connectivity group via service import component 1018 in a request/response format 1020.

In the interaction patterns shown in FIG. 8 through FIG. 10, a simplified example is presented in which a single enterprise information system connectivity group communicates with a single process group. However, a single enterprise information system connectivity group can interact with multiple process groups. Similarly, multiple process groups can interact with a single connectivity group and multiple process groups may interact with multiple connectivity groups.

Multiple connectivity between groups can affect the patterns shown in FIG. 8 through FIG. 10. In the event delivery interaction pattern shown in FIG. 8, multiple connectivities would not affect group definitions because the groups communicate indirectly through a topic. However, for enterprise information system initiated requests shown in FIG. 10 and process initiated requests shown FIG. 9, the appropriate import and export commands should be included in the modules that are to interact with each other.

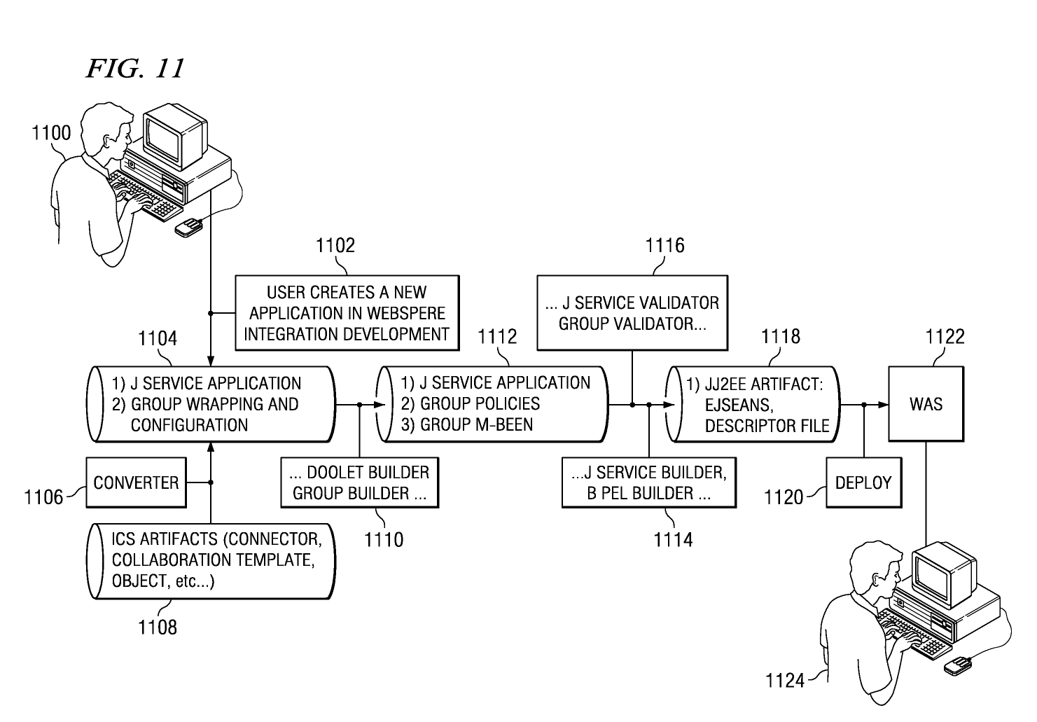

FIG. 11 is a block diagram of an application development process using groups of the present invention, in accordance with an illustrative example of the present invention. The application development process shown in FIG. 11 can be implemented using a number of data processing systems, such as clients 110, 112, and 114 in FIG. 1, servers 104 and 106 in FIG. 1, and data processing system 200 in FIG. 2. In addition, the application development process shown in FIG. 11 uses the WEBSPHERE BUSINESS INTEGRATION® system shown in FIG. 4; however, the application development process shown in FIG. 11 can also be implemented in the process server system shown in FIG. 3. In the application development process shown in FIG. 11, cylinders represent data objects and boxes represent processes or function calls.

The application development process shown in FIG. 11 can define a number of policies that apply to a number of enterprise information system connectivity groups and a number of process groups. The application development process can automatically generate JMX MBeans and startup beans, add policy handlers to service component architecture component kinds, validate that appropriate policies are applied to groups, and validate that group components are interconnected correctly within a group and across groups.

In the application development process shown in FIG. 11, user 1100 first creates a new application in a WEBSPHERE® integration development application at block 1102. The WEBSPHERE® integration application provides a graphical development environment to a user, though the WEBSPHERE® integration application can run in headless Eclipse mode. In either case, user 1100 creates a WEBSPHERE® group project. User 1100 specifies whether the WEBSPHERE® group project is a process group or an enterprise information system connectivity group. Each project produces a service component architecture application 1104 in which group wrapping and configuration are provided.

Next, user 1100 adds service component architecture application components as shown in block 1108 via converter 1106. Service component architecture application components include business integration server artifacts, including connectors, collaboration templates objects, and other artifacts. Service component architecture application components also can include component interfaces, component implementation, and any wiring files that are used to establish the relationships between components in a group and the relationships between groups. The WEBSPHERE® integration development application provides user 1100 with tools, such as graphical tools, that allow user 1100 to automatically apply service component architecture policies to the service component architecture application. In addition, the WEBSPHERE® integration development application ensures that components within a group are correctly interrelated and that groups are correctly interrelated.

When user 1100 saves or builds the project in 1104, the WEBSPHERE® integration development application invokes WEBSPHERE® rapid deployment builders, validators, and doclet builders, group builders, Bpel builders, service component architecture builders, and other builders, as shown in block 1110 and block 1114. The appropriate builders are associated with the group project type. When the group builder is called, the group builder will generate a managed bean for group administration purposes, as shown in block 1112 and block 1114. In addition, the group builder will generate a startup bean that will help initialize the application under development, as shown in block 1112.

Next, group validators, such as a service component architecture validator, are called to ensure that subcomponents within a group follow the rules appropriate to the group type, as shown in block 1116. Group validators also ensure that policies on component interfaces, references, and connections are applied correctly. Next, J2EE (Java2 Enterprise Edition) artifacts such as EJBs (Enterprise Java Beans), and a deployment descriptor file are produced, as shown in block 1118. Any errors are flagged. User 1100 corrects these errors before the project is deployed to WEBSPHERE® application server (WAS) 1122 at block 1120. User 1124 then monitors and manages the developed group through the MBean. The developed group runs on WEBSPHERE® application server 1122

FIG. 12 is a flowchart illustrating generation and use of business integration component group pattern-based applications. The process shown in FIG. 12 can be implemented in the process server system of FIG. 3, FIG. 4, or FIG. 5. The process shown in FIG. 12 can be implemented using a number of data processing systems, such as clients 110, 112, and 114 in FIG. 1, servers 104 and 106 in FIG. 1, and data processing system 200 in FIG. 2. Each individual component in a group shown in FIG. 12 may be characterized as an application integration component.

Initially, an application receives user input to establish connectivity groups (step 1200). The application also receives user input to establish process groups (step 1202). As part of establishing connectivity groups and process groups, the connectivity groups and the process groups are deployed to one or more physical servers and subsequently enabled. Connectivity groups and process groups may be established using the processes and components described with respect to FIG. 11.

For the remaining steps described with respect to FIG. 12, one or more applications, such as integration applications, perform the described steps. However, a user also may perform manually any of the remaining steps described with respect to FIG. 12.

After establishing connectivity groups and process groups, an integration application assess the state of the connectivity groups and the process groups (step 1204). As described with respect to FIG. 5, each of the connectivity groups and the process groups can have a variety of different states. The illustrative example of FIG. 12 describes processing three states: Active, paused, and inactive.

If a connectivity group or a process group is in an active state, then all components within each group function normally (step 1208). Similarly, groups interact with each other normally, such as the interactions shown in FIG. 3 through FIG. 5 and in FIG. 8 through FIG. 10. Later, a user can administer groups and administer components within groups by issuing commands to the groups (step 1210). The process terminates thereafter.

Returning to step 1204, if a connectivity group is paused (step 1212), then an integration application can adjust components within the paused connectivity group, can adjust components within other connectivity groups, and can adjust other connectivity groups themselves (step 1214). A connectivity group or a component within a connectivity group may be adjusted by pausing the component, stopping the component, or performing some other action with respect to the component. Similarly, an integration application can adjust components within process groups and can adjust process groups themselves (step 1216). For example, a process component can be paused or stopped in response to pausing a connectivity component, as described with respect to FIG. 5.

Optionally, a user or an integration application can deploy one or more resiliency policies (step 1218). A resiliency policy is a policy that an integration application or a group can use to attempt to return a group or a component within a group to an active state. If the group and/or the components in question return to an active state, then the process can return to step 1204, in which case normal functioning continues. If necessary or desirable, a user can administer components or groups via group commands (step 1210), as described above. The process terminates thereafter.

Returning to step 1204, if a process group is paused (step 1220), then an integration application can adjust components within the paused process group, can adjust components within other process groups, and can adjust other process groups themselves (step 1222). A process group or a component within a process group may be adjusted by pausing the component, stopping the component, or performing some other action with respect to the component. Similarly, an integration application can adjust components within connectivity groups and can adjust connectivity groups themselves (step 1224). For example, a connectivity component can be paused or stopped in response to pausing a process component, as described with respect to FIG. 5.

Optionally, a user or an integration application can deploy one or more resiliency policies (step 1218). A resiliency policy is a policy that an integration application or a group can use to attempt to return a group or a component within a group to an active state. If the group and/or the components in question return to an active state, then the process can return to step 1204, in which case normal functioning continues. If necessary or desirable, a user can administer components or groups via group commands (step 1210), as described above. The process terminates thereafter.

Returning to step 1204, if a component or a group is in an inactive state (1226), then an integration application can adjust components within the inactive process group or component, can adjust components within other process groups, and can adjust other process groups themselves (step 1228). A process group or a component within a process group may be adjusted by pausing the component, stopping the component, or performing some other action with respect to the component. Similarly, an integration application can adjust components within connectivity groups and can adjust connectivity groups themselves (step 1230). For example, a connectivity component can be paused or stopped in response to a process component entering an inactive state, or visa versa, as described with respect to FIG. 5.

Optionally, a user or an integration application can deploy one or more resiliency policies (step 1218). A resiliency policy is a policy that an integration application or a group can use to attempt to return a group or a component within a group to an active state. If the group and/or the components in question return to an active state, then the process can return to step 1204, in which case normal functioning continues. If necessary or desirable, a user can administer components or groups via group commands (step 1210), as described above. The process terminates thereafter.

The process shown in FIG. 12 and the block diagram of FIG. 5 show a computer implemented method of managing a plurality of application integration components. A first command is issued to a first application group. The first application group includes a first subset of application integration components selected from a number of application integration components. The first command causes at least one application integration component in the first subset of application integration components to be adjusted based on a first policy. Responsive to issuing the first command, and based on a second policy, a second command is issued to a second application group. The second application group includes a second subset of application integration components selected from the number of application integration components. The second command causes at least one application integration component in the second subset of application integration components to be adjusted based on the second policy.

FIG. 13 shows pseudo-code that describes the policy-type transaction in a service component architecture. Service component architectures are described with respect to FIG. 4 and FIG. 5, and are described elsewhere herein.

The aspects of the present invention have several advantages over present methods of administering process server systems. For example, groups encapsulate the rules that to ensure correct behavior for all components within a group. Therefore, the mechanism of the present invention simplifies the development and deployment of complex integration of business applications. Without the use of groups, a user sifts through a rules document to ensure correct behavior of all business applications. In addition, groups allow well-defined sets of components to be deployed independently of each other. Thus, a user can isolate groups to administer individual groups independently without necessarily affecting other groups within a system.

In the context of WEBSPHERE® business integration applications, groups support business integration server functions. Furthermore, business process group templates preserve the functionality of business integration server collaboration groups. This fact, in turn, helps users upgrade older or different collaboration groups to WEBSPHERE® business integration applications; thereby increasing sales of that application.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of managing a plurality of application integration components, the computer implemented method comprising:
issuing a first command to a first application group, the first application group comprising a first subset of application integration components selected from the plurality of application integration components, wherein the first command causes at least one application integration component in the first subset of application integration components to be adjusted based on a first policy; and
responsive to issuing the first command, and based on a second policy, issuing a second command to a second application group, the second application group including a second subset of application integration components selected from the plurality of application integration components, wherein the second command causes at least one application integration component in the second subset of application integration components to be adjusted based on the second policy.

2. The computer implemented method of claim 1 further comprising:
prior to issuing the first command, defining the first application group.

3. The computer implemented method of claim 1 further comprising:
prior to issuing the second command, defining the second application group.

4. The computer implemented method of claim 1 wherein the first subset of application integration components is a connectivity group.

5. The computer implemented method of claim 4 wherein the second subset of application integration components is a process group.

6. The computer implemented method of claim 5 wherein the first command causes operation of at least one of the application integration components in the connectivity group to be paused and wherein the second command causes operation of at least one of the application integration components in the process group to be paused.

7. The computer implemented method of claim 6 further comprising:
deploying a resiliency policy to the connectivity group.

8. The computer implemented method of claim 7 further comprising:
responsive to the resiliency policy causing reinstatement of operation of the at least one of the application integration components in the connectivity group, reinstating operation of the at least one of the application integration components in the process group.

9. The computer implemented method of claim 1 wherein the first command and the second command are issued by an application.

10. A computer program product comprising:
a computer usable medium having computer usable program code for managing a plurality of application integration components, said computer program product including:
computer usable program code for issuing a first command to a first application group, the first application group including a first subset of application integration components selected from the plurality of application integration components, wherein the first command adjusts at least one application integration component in the first subset of application integration components; and
computer usable program code for responsive to issuing the first command, issuing a second command to a second application group, the second application group including a second subset of application integration components selected from the plurality of application integration components, wherein the second command adjusts at least one application integration component in the first subset of application integration components.

11. The computer program product of claim 10 further comprising:
computer usable program code for, prior to issuing the first command, defining the first application group; and
computer usable program code for, prior to issuing the second command, defining the second application group.

12. The computer program product of claim 10 wherein the first subset of application integration components is a connectivity group and the second subset of application integration components is a process group.

13. The computer program product of claim 12 wherein the first command pauses operation of at least one of the application integration components in the connectivity group and wherein the second command pauses operation of at least one of the application integration components in the process group.

14. The computer program product of claim 13 further comprising:
computer usable program code for deploying a resiliency policy to the connectivity group.

15. A data processing system comprising:
a bus;
a memory connected to the bus, wherein the memory contains computer usable instructions; and
a processor connected to the bus, wherein the processor is adapted to execute the computer usable instructions to:
issue a first command to a first application group, the first application group including a first subset of application integration components selected from the plurality of application integration components, wherein the first command adjusts at least one application integration component in the first subset of application integration components; and
responsive to issuing the first command, issue a second command to a second application group, the second application group including a second subset of application integration components selected from the plurality of application integration components, wherein the second command adjusts at least one application integration component in the first subset of application integration components.

16. The data processing system of claim 15 wherein the processor is further adapted to execute the computer usable instructions to:
prior to issuing the first command, define the first application group; and
prior to issuing the second command, define the second application group.

17. The data processing system of claim 15 wherein the first subset of application integration components is a connectivity group and the second subset of application integration components is a process group.

18. The data processing system of claim 17 wherein the first command pauses operation of at least one of the application integration components in the connectivity group and wherein the second command pauses operation of at least one of the application integration components in the process group.

19. The data processing system of claim 18 wherein the processor is further adapted to execute the computer usable instructions to:
deploy a resiliency policy to the connectivity group.

20. The data processing system of claim 19 wherein the processor is further adapted to execute the computer usable instructions to:
responsive to the resiliency policy causing reinstatement of operation of the at least one of the application integration components in the connectivity group, reinstate operation of the at least one of the application integration components in the process group.
